(19) United States
(12) Patent Application Publication
(10) Pub. No.: US 2006/0214796 A1
(43) Pub. Date: Sep. 28, 2006

(54) Item check-out management system

(75) Inventor: Atsushi Ishikawa, Izunokuni (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: Toshiba Tec Kabushiki Kaisha, Shinagawa-ku (JP)

(21) Appl. No.: 11/353,912

(22) Filed: Feb. 14, 2006

(30) Foreign Application Priority Data
Mar. 25, 2005 (JP) 2005-088899

(51) Int. Cl. G08B 13/14

(52) U.S. Cl. 340/572.1; 340/10.51

(57) ABSTRACT

By storing check-out procedure data into a radio tag and by providing a leaving allowance judgment portion at an exit gate, it is possible to judge whether a user is allowed to leave at an exit section alone. It is thus possible to shorten a time needed for a leaving allowance judgment.

### CROSS-REFERENCE TO RELATED APPLICATIONS

This application is based upon and claims the benefit of priority from the prior Japanese Patent Application No. 2005-88899, filed on 25th Mar., 2005; the entire contents of which are incorporated herein by reference.

### BACKGROUND OF THE INVENTION

(1) Field of The Invention

The present invention relates to an item check-out management system to manage items by attaching a radio tag to each item, such as book check-out management in a library, and vide tape check-out management in a rental shop.

(2) Description of The Related Art

In a library or a rental video shop, books or video tapes are now practically managed by attaching a radio tag to each, so that check-out and check-in of a large volume of books or video tapes can be managed efficiently. For example, in a case of a library, a radio tag accommodating an IC, an antenna, and so forth is attached to each book kept at the library for general public perusal. The radio tag stores unique ID data. Detailed data for each book is correlated with the radio tag unique ID data and stored in a database of a host computer installed within the library.

When a user checks out a book he wishes to borrow, he brings the book to the check-out counter. The library staff then reads out the ID data of the radio tag attached to the book using a reader/writer he carries around or installed on the desk. The ID data thus read is processed in the host computer. The host computer then updates the circulation status data of the book in the database from “being held” to “checked out”

When the user passes through the exit gate with a book kept at the library, a reader/writer installed at the exit gate reads out the ID data of the radio tag attached to the book. A reference is made to the host computer as to the read ID data to judge whether the book is properly checked out. When it is confirmed that the check-out procedure has been properly completed, a corresponding signal is transmitted to the exit gate to open the gate for the user to leave. When the user has not finished the proper check-out procedure, he is not allowed to leave from the result of the reference made to the host computer as to the ID data read out from the radio tag attached to the book (for example, see JP-A-2004-151821).

In a case of the library, with the management system using a radio tag attached to each book kept at the library, the reader/writer installed at the exit gate reads out the ID data stored in the radio tag when a user tries to pass through the exit gate with a book kept at the library. A reference is made to the host computer installed outside the exit gate as to the ID data. Subsequently, whether the proper check-out procedure has been completed is judged, and the exit gate is controlled to open or close according to the judgment result.

This management system, however, involves the reading of the ID data at the exit gate, reference transmission to the host computer, reference processing in the host computer, and transmission of the reference result to the exit gate. As a result, it takes a long time since the user arrives at the exit gate until whether he is allowed to pass through the exit gate is judged.

### BRIEF SUMMARY OF THE INVENTION

According to embodiments of the present invention, an object of the invention is to provide an item check-out management system enabling a check-out reference at a high speed using a simple configuration.

The present invention may provide an item check-out management system to check out from a facility an item to which a radio tag storing unique ID data is attached, including: a writing portion that writes check-out procedure completion data into the radio tag when a check-out procedure of the item is performed; a reader/writer installed at an exit gate of the facility to read out the unique ID data and the check-out procedure completion data stored in the radio tag; and a leaving allowance judgment portion that judges whether a proper check-out procedure has been completed according to data read out from the radio tag, and outputs a signal to allow a user to leave through the exit gate upon judging that the proper check-out procedure has been completed.

### BRIEF DESCRIPTION OF THE DRAWINGS

FIG. 1 is a view showing the configuration of a system according to one embodiment of the invention;

FIG. 2 is a view showing the data structure used to describe one embodiment of the invention;

FIG. 3 is a flowchart detailing operations in one embodiment of the invention; and

### DETAILED DESCRIPTION OF THE INVENTION

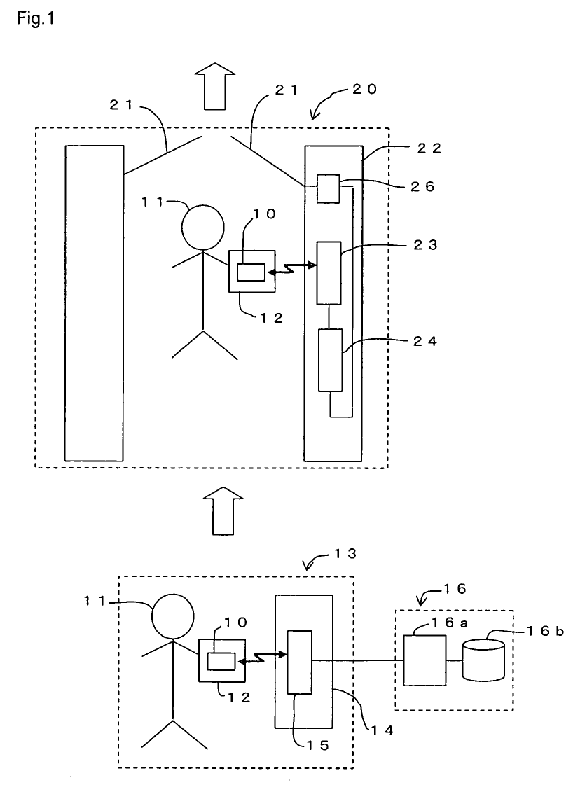

One embodiment of the invention will now be described with reference to the drawings using a library as an example. FIG. 1 is a view showing the configuration of a management system of the invention. When a user 11 checks out a book 12 kept at the library he wishes to borrow, he has to complete the necessary procedure at a check-out management section 13. A reader/writer 15 is installed on a check-out counter 14 in the check-out management section 13.

A radio tag 10 is attached to each book kept at the library. Although detailed descriptions are omitted herein because the radio tag 10 has been used in diversified fields, the radio tag 10 comprises an IC chip, an antenna, and so forth, and stores inside the radio tag unique ID data. The radio tag 10 has acapability of making communications with an outside reader/writer using radio waves.

When the user 11 comes to the check-out counter 14 with the book 12 to which the radio tag 10 is attached, the radio tag unique ID data stored in the radio tag 10 is read out by the check-out reader/writer 15. The ID data read by the check-out reader/writer 15 is transmitted to a host computer 16. The host computer 16 includes a control portion 16a and a database 16b. For each book kept at the library, the radio tag unique ID data, library registration unique ID data, book classification data, bibliography data, check-out data, check-out judgment data, etc. are correlated with one another and stored in the database 16b. Typical data as the check-out data includes the date of check-out, registration data unique to a user who borrowed the book. The check-out judgment data is indicated by a numeral code. For example, “0” indicates that the check-out has not been registered, and “1” indicates that the check-out has been registered.

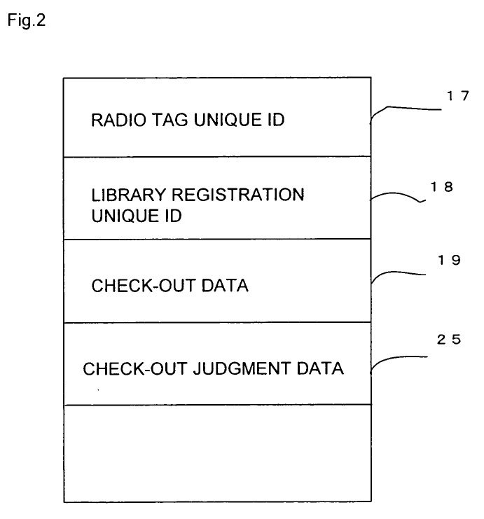

As has been described, corresponding data in the database 16b is updated via the control portion 16a of the host computer 16. After the update, new data from the host computer 16 is written into the radio tag 10 attached to the book 12 upon completion of the check-out procedure. More specifically, FIG. 2 shows the data structure stored in the radio tag 10. In addition to the radio tag unique ID data 17 that has been originally stored, library registration unique ID data 18 unique to the book that has been checked out, check-out data 19, and check-out judgment data 25 are stored into the radio tag 10. The data from the host computer 16 is written into the radio tag 10 by the check-out reader/writer 15 installed at the check-out counter 14.

The user 11, having completed the check-out procedure as has been described, comes to an exit section 20 with the book 12. The exit section 20 is provided with an exit gate 22 having an opening/closing gate 21. Once a user enters into the library, he cannot leave unless he passes through the exit gate 22 regardless of whether he is holding a book kept at the library. When the user passes through the exit gate 22 with the book 12 kept at the library, communications are made between the radio tag 10 attached to the book 12 and an exit reader/writer 23 installed at the exit gate 22.

The exit reader/writer 23 reads out various kinds of data stored in the radio tag 10 including the data written into the radio tag 10 at the check-out management section 13. The various kinds of data read by the exit reader/writer 23 is inputted into a leaving allowance judgment portion 24. The leaving allowance judgment portion 24 checks whether the proper check-out procedure has been completed on the basis of check-out data 19 stored in the radio tag 10 shown in FIG. 2. Upon judging that the check-out procedure has been completed properly, the leaving allowance judgment portion 24 judges that the user 11 is allowed to leave and transmits a command signal to a gate opening/closing control portion 26 for the opening/closing gate 21 to open. The user 11 is thus allowed to leave by passing through the opening/closing gate 21.

As has been described, by writing various kinds of data needed for a check-out procedure, such as the check-out data 19, into the radio tag 10 attached to the book 12 the user 12 is holding at the check-out management section 13, it is possible to judge whether the user 11 is allowed to leave at the exit section 20 alone without having to make a reference to the host computer 16. In other words, by storing the check-out procedure data in the radio tag 10 and by providing the leaving allowance judgment portion 24 at the exit gate 22, whether the user 11 is allowed to leave can be judged at the exit section 20 alone. It is thus possible to shorten a time needed for a leaving allowance judgment.

In the case described above, the exit reader/writer 23 merely reads out data from the radio tag 10. However, the exit reader/writer 23 may write updated check-out judgment data 25 shown in FIG. 2 into the radio tag 10 when the leaving allowance judgment portion 24 confirms the completion of the proper check-out procedure. More specifically, the check-out judgment data 25 that has been stored in the radio tag 10 and currently exhibits “1” indicating that the check-out registration has been completed is updated to a numeral code “2” indicating that the user 11 has left the library from the exit gate 22 and the item is being checked out.

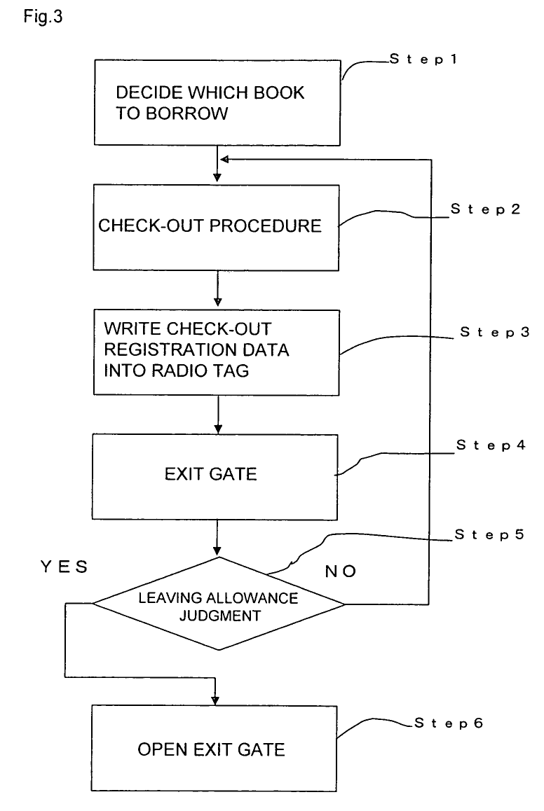

Operation steps in one embodiment of the invention will now be described with reference to the flowchart shown in FIG. 3. When a user decides a book he wishes to check out inside the library (Step 1) , the user brings the book, to which the radio tag is attached, to the check-out section. The check-out registration is carried out at the check-out section (Step 2), and various kinds of check-out registration data is written into the radio tag (Step 3). Having completed the check-out registration, the user arrives at the exit section to pass through the exit gate (Step 4). A leaving allowance judgment is made at the exit gate, and when it is judged that the user is allowed to leave, the check-out judgment data in the radio tag is updated (Step 5) while the exit gate is opened for the user to leave (Step 6). When it is judged that the proper check-out procedure has not been completed as the result of the leaving allowance judgment, the user is requested to go through the check-out procedure again while the exit gate remains closed.

The embodiment of the invention has been described using the check-out management in the library by way of example. The invention, however, is also applicable to a system that needs data registration and a judgment as to whether the user is allowed to leave at the exit gate when an item, to which the radio tag is attached, is checked out from the facility, such as a rental video shop.

It goes without saying that various obvious modifications and simple variants come within the scope of the present invention beyond the above-described embodiment.

What is claimed is:

1. An item check-out management system to check out from a facility an item to which a radio tag storing unique ID data is attached, comprising:
a writing portion that writes check-out procedure completion data into the radio tag when a check-out procedure of the item is performed;
a reader/writer installed at an exit gate of the facility to read out the unique ID data and the check-out procedure completion data stored in the radio tag; and
a leaving allowance judgment portion that judges whether a proper check-out procedure has been completed according to data read out from the radio tag, and outputs a signal to allow a user to leave through the exit gate upon judging that the proper check-out procedure has been completed.

2. The item check-out management system as set forth in claim 1, wherein:
the reader/writer writes data indicating that the item is being checked out into the radio tag when the leaving allowance judgment portion judges that the proper check-out procedure has been completed.

3. The item check-out management system as set forth in claim 2, wherein:
the facility is a library and the item is a book.
